(19) United States
(12) Patent Application Publication
(10) Pub. No.: US 2013/0090245 A1
(43) Pub. Date: Apr. 11, 2013

(54) METHOD FOR COOLING SUPERCONDUCTING JOINTS

(71) Applicant: Michael Simpkins, Holmer Green (GB)

(72) Inventor: Michael Simpkins, Holmer Green (GB)

(73) Assignee: Siemens PLC, Camberley (GB)

(21) Appl. No.: 13/806,116

(22) PCT Filed: Jun. 13, 2011
(86) PCT No.: PCT/GB11/51094

§ 371 Date: Dec. 20, 2012

(30) Foreign Application Priority Data
Jul. 8, 2010 (GB) 1011475.9

(51) Int. Cl. H01B 12/16

(52) U.S. Cl. CPC H01B 12/16
USPC 505/231; 505/300; 164/110; 174/84 R

(57) ABSTRACT

A superconducting joint that electrically joins superconducting wires has a block of thermally and electrically conductive material that is coated with an electrically isolated coating that covers at least a part of a surface of the block. Molded semiconducting joint material is provided in contact with the electrically isolating coating. Superconducting filaments of the superconducting wires are embedded within the molded superconducting joint material.

### BACKGROUND OF THE INVENTION

1. Field of the Invention

The present invention relates to superconducting joint cups and methods for cooling superconducting joints.

2. Description of the Prior Art

It is known to produce relatively large electromagnets of superconducting wire for use, for example in magnetic resonance imaging (MRI) systems. Known magnets for MRI systems may be 2 m in diameter, 1.5 m in length and include many tens of kilometers of wire. Commonly, the magnets are composed of several relatively short coils, spaced axially along the axis of a cylindrical magnet, although several other designs are known, and the present invention is not limited to any particular magnet design.

Such superconducting magnets are not normally wound from a single length of superconducting wire. If several separate coils are used, they are usually produced separately and electrically joined together during assembly of the magnet. Even within a single coil, it is often necessary to join several lengths of wire together.

Joins between superconducting wires are difficult to make. Optimally, the join itself will be superconducting—that is, having a zero resistance when the magnet is in operation. This is often compromised, and “superconducting” joints are often accepted which have a small resistance.

A common known manner of making a superconducting joint is to take the lengths of superconducting wire, and strip any outer cladding, typically copper, from the superconducting filaments over a length of about one meter. The superconducting filaments of the two wires are then twisted together to provide good contact between the superconducting filaments of the two wires. The resulting twist of filaments is then coiled into a joint cup: a fairly shallow vessel, typically of copper. The joint cup is then filled with a superconducting material, typically liquid Woods metal, which cools and solidifies to embed the twist in a superconductive mass. A typical joint cup may be a cylindrical vessel, closed at one end, with a diameter of about 4 cm, and a height of about 4 cm. FIG. 1 shows a conventional joint cup 10, into which wires 12 are introduced with their superconducting filaments 14 twisted together. The joint cup is typically filled to the brim with a liquid superconducting joint material, such as molten Woods metal. The superconducting joint material is then allowed, or caused, to solidify.

The present invention does not seek to change any of these features or method steps, but relates to the joint cup itself.

Conventionally, superconducting magnets have been cooled by partial immersion in a bath of liquid cryogen, typically helium. This maintains the coils at a temperature below their superconducting transition temperature. By immersing the superconducting joints within the liquid cryogen, they can also be maintained below the superconducting transition temperature.

However, recent designs of magnets have avoided the cryogen bath, as being costly and in some circumstances wasteful of cryogen. These designs may be provided with a cooling loop or thermosiphon: a thermally conductive tube in thermal contact with the magnet carries a circulating cryogen, which is cooled, introduced into the tube where it extracts heat from the magnet, expands or boils and circulates by thermal convection back to a reservoir where it is re-cooled. Circulation may be gravity induced or be assisted by any suitable means, such as a pump. A much smaller volume of cryogen is required than in an arrangement employing a cryogen bath. Cooling of the magnet coils is by conduction, through the wall of the tube, and possibly through the material of a structure supporting the magnet coils, such as a former. In other superconducting magnets, no cryogen is used at all. The magnet coils are cooled by thermal conduction, typically through a conductive conduit such as a copper braid or laminate, to a cryogenic refrigerator. Such arrangements are known as dry magnets.

In each of these cases, cooling of the joints is less effective than the more conventional immersion in liquid cryogen.

### SUMMARY OF THE INVENTION

The present invention accordingly seeks improved superconducting joints and methods for cooling superconducting joints to enable the superconducting joints to be sufficiently cooled in magnets which are not cooled by immersion in a liquid cryogen.

The above object is achieved in accordance with the present invention by a superconducting joint for electrically joining superconducting wires, and a method for pooling such a superconducting joint, wherein a block of thermally and electrically conductive material is arranged to be cryogenically cooled, an electrically isolating coating is provided that covers at least a part of a surface of the block, a molded superconducting joint material is placed in contact with the electrically isolating coating, and superconducting filaments of the superconducting wires are embedded within the molded superconducting joint material.

### BRIEF DESCRIPTION OF THE DRAWINGS

FIG. 1 shows a conventional superconducting joint using a joint cup for filling with Woods metal.

FIG. 2 shows a cooled block comprising a joint cup cavity according to an aspect of one embodiment of the present invention, with wires for joining arranged therein.

FIG. 3 shows a cut-away view of the cooled block of FIG. 2.

FIG. 4 shows a cut-away view of a cooled block comprising a joint cup cavity according to another embodiment of the invention.

FIG. 5 shows a cut-away view of a cooled block comprising a joint cup cavity according to another embodiment of the invention.

FIGS. 6-9 show steps in a method of forming superconducting joints according to an embodiment of the invention.

FIG. 10 shows a view of a superconducting joint according to an embodiment of the invention.

### DESCRIPTION OF THE PREFERRED EMBODIMENTS

In order to manufacture low cryogen inventory superconducting magnets—that is, those which do not rely on cooling by immersion in a bath of cryogen, but are cooled by a reduced volume of cryogen, for example in a thermosiphon or cooling loop—or dry superconducting magnets—that is, those which are not cooled by cryogen at all, but rely, for example, on thermal conduction cooling to a cryogenic refrigerator—it is necessary to produce suitably cooled superconducting joints which do not require cooling by immersion in cryogen.

One approach to this problem may be in using flexible thermal conductors such as copper or aluminum braids or laminates thermally linking joints to a refrigerator, or by attaching superconducting joints to a cooled component using an electrically isolating adhesive layer. This latter approach is described, for example, in GB 2453734 (equivalent to US 2009/0101325 A1).

A difficulty with this latter option arises in achieving sufficient electrical isolation while maintaining adequate thermal conduction for effective cooling of superconducting joints. This generally leads to multiple interfaces between cooled component and superconducting joint, as may be seen in some of the examples described in GB 2453734.

The present invention provides improved superconducting joints and improved methods for forming superconducting joints. In some embodiments only a single electrically isolating coating is positioned between the superconducting joint and the cooled component. That electrically isolating coating is much thinner, and is more thermally conductive, than the electrically isolating layers in arrangements provided by the prior art.

In alternative embodiments, the cooled component is itself formed of electrically isolating, thermally conductive material.

Bonded or bolted joints are avoided where possible, as these can impede cooling of the superconducting joint.

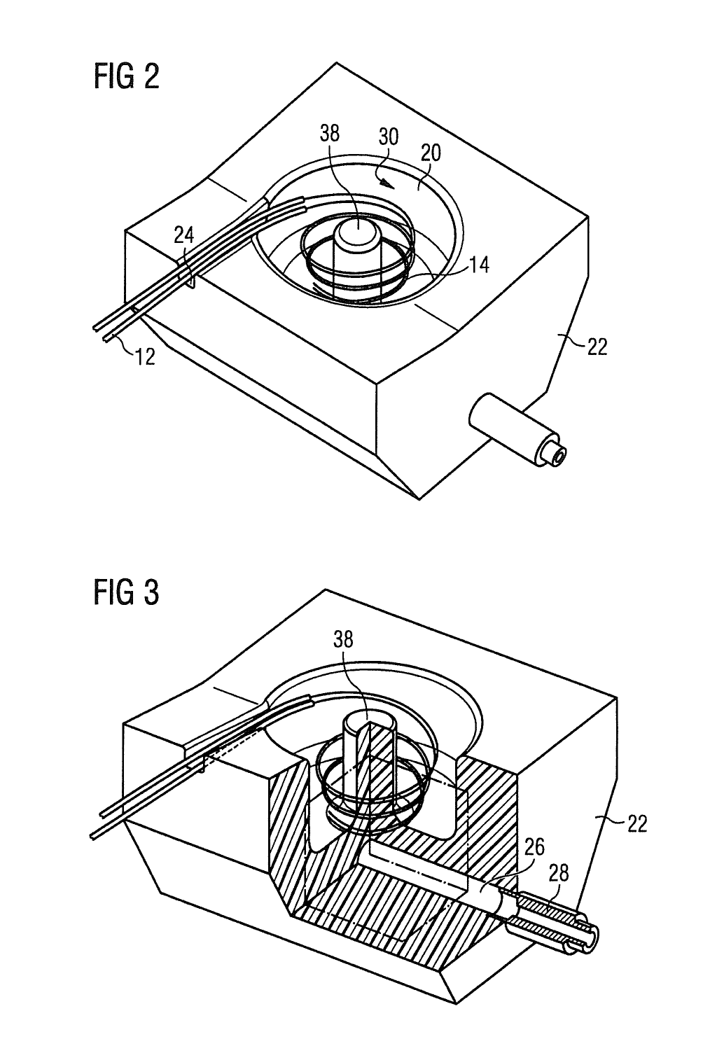

FIG. 2 shows a joint cup for forming a superconducting joint according to an embodiment of the present invention. The cup comprises a cavity 20 formed in a cooled block 22 of thermally conductive material. In this case, the block 22 is of aluminum. Preferably, and as illustrated, a channel 24 is provided, and wires 12 to be joined are arranged to run along the channel and in to the cavity 20. The twist 14 of superconducting filaments is coiled into the cavity as shown. The cavity 20 may then be filled with a superconducting jointing material, such as molten Woods metal. The joint cup in this embodiment includes a through-passage 26, visible in the cut-away view of FIG. 3. The through-passage terminates at each end in a fluid connector 28. In use, a cryogen fluid, such as liquid helium, is arranged to flow through the fluid connectors 28 and the through-passage 26, and so to cool the block 22 which includes the joint cup. The through-passage 26 is positioned in a circuit for coolant flow in a thermosiphon or cooling loop arrangement as desired. The block 22 is accordingly cooled to the temperature of the cryogen fluid, which should be below the superconducting transition temperature of the superconducting wires and the superconducting jointing material.

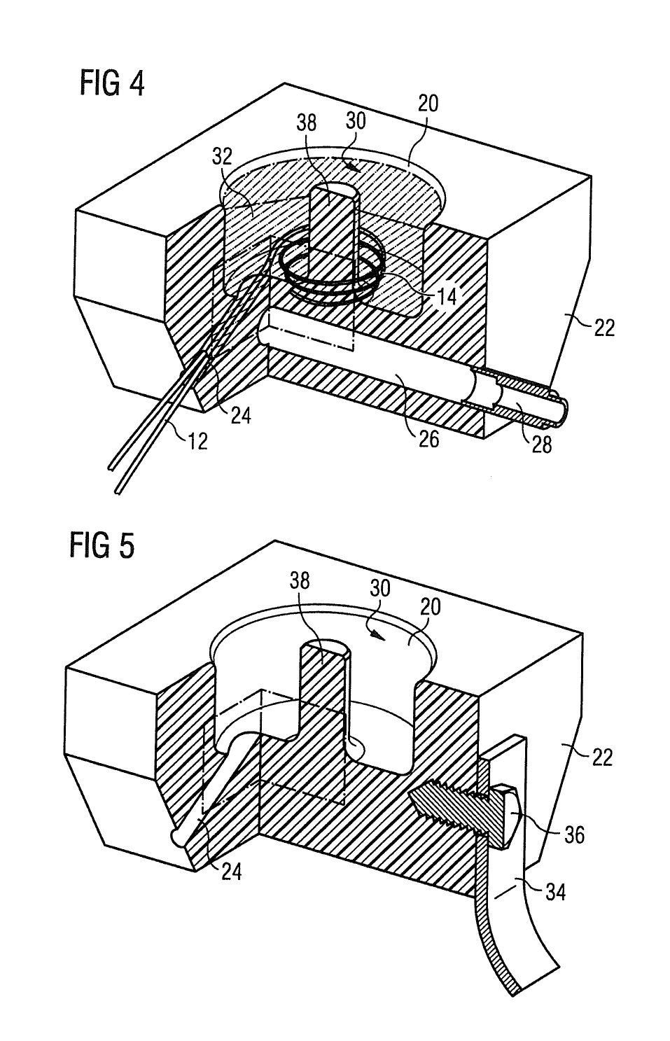

FIG. 4 shows a cut-away view of another embodiment of the present invention. In this embodiment, the channel 24 enters the joint cup cavity 20 from below. The superconducting joint material 32 is shown, filling the joint cup cavity 20 and the channel 24. During assembly, a seal of some sort—for example a clay capable of withstanding the temperature of molten superconducting material—should be placed within the channel 24 to prevent the superconducting joint material 32 from leaking out. This alternative joint cup cavity geometry is believed to suit certain coating processes and permits wires 12 to enter from the base of the cavity 20, should such an arrangement be desired.

FIG. 5 shows another embodiment of the present invention. It is similar to the arrangement of FIG. 4, but comprises no through-channel 26 or fluid connectors 28. Rather, a flexible thermal conductor 34, in this example a flexible laminate such as a copper or aluminum laminate, is securely attached, in this example by bolt or screw 36 to a surface of the block 22. It is important in such embodiments that there should be no thermally isolating layer on the joining surfaces of the block 22 and the flexible thermal conductor 34. If preferred, a thermally conductive interface, such as an indium washer, may be interposed between the block and the flexible thermal conductor to ensure effective heat transfer from the block to the flexible thermal conductor. The other end of the flexible thermal conductor will be attached to a cooled surface, for example a cooling surface of a cryogenic refrigerator. This connection to the refrigerator may be indirect, in that the flexible thermal conductor 34 may be attached to another article which is itself thermally connected to a cooling surface of a cryogenic refrigerator. The flexible thermal conductor 34 may be a thermally conductive braid, such as a copper or aluminum braid. The flexible thermal conductor 34 may be replaced by a rigid thermal conductor such as an aluminum or copper bar.

In another alternative, the cooled block may be in direct contact with the cryogenic refrigerator, omitting the thermal link.

The cooled block may also serve as a thermal link between refrigerator and magnet in a dry system.

In all of the embodiments described with reference to FIGS. 2-5 the surfaces of the cavity 20 and the channel 24, if any, are covered with an electrically isolating coating 30. The upper and other outer surfaces of the block 22 may also be covered with this or any other electrically isolating coating except for the surface of the block 22 which joins the conductor 34 in embodiments such as discussed with reference to FIG. 5. In the illustrated example, the coating may be a coating of aluminum oxide formed on an aluminum block 22 by anodizing or any other suitable process. The through-passage 26 may be formed after the formation of the aluminum oxide coating to prevent a thermally resistive layer being formed within the through-passage. This may be by drilling. Alternatively, the through-passage may be formed before the formation of the electrically isolating coating, with the through-passage being sealed during formation of the coating, or the coating may be removed from the through-passage in a later step. The electrically isolating coating 30 must be sufficient to withstand the highest expected voltages which may occur, for example during a quench of the superconducting magnet. A common requirement is for the electrical isolation to be effective to at least 6 kV.

In alternative embodiments, the block may be of copper, or a composite material containing thermally conductive filler such as aluminum or copper powder or copper wool to provide the required thermal conductivity. A copper block may have a thin coating, for example of copper oxide, a ceramic or a polymer layer formed or deposited on the surface 30 of the cavity 20. A block of composite material may be provided with an electrically isolating layer 30 of a polymer or resin, particularly if an electrically conductive filler is used, for example copper wool.

In an example embodiment, in which superconducting joints are formed linking wires together in superconducting magnets for an MRI system, it was found necessary to provide electrical isolation to at least 6 kV, to withstand the very high voltages typically generated during a quench event. Particular examples of suitable coatings include:

a physical vapor deposited layer of polymer, to a thickness of approximately 25 μm;

a sprayed-on ceramic layer, to a thickness of 230-255 μm;

aluminum oxide, to a thickness of about 250 μm, formed by anodizing the surface of an aluminum block.

A physical vapor deposition process was found particularly beneficial in applying a coating of constant thickness to all exposed surfaces.

Other coatings may be used, and may be applied by a slurry or dipping process, or painted on.

In other embodiments, the block 22 may be of a machinable glass ceramic material, such as those marketed under the MACOR® brand by Ceramic Substrates and Components Ltd, Lukely Works, Carisbrooke Road, Newport, Isle of Wight, United Kingdom PO30 1DH (www.macor.info). In such embodiments, the material itself is electrically isolating, and so there is no need to provide an electrically isolating coating inside the cavity 20. The material may be machined by conventional methods such as drilling, milling and cutting. In similar embodiments, a block of filled resin may be provided with the joint cup cavity and coolant through-channel molded in, or machined in. A suitable resin may be Emerson and Cuming STYCAST® 2850 GT resin, which has a relatively high thermal conductivity, yet also a high electrical resistivity. In such arrangements, there may be no need to apply a surface coating, as the material of the block may have sufficient qualities of electrical isolation and thermal conduction. The channel 24 may be formed by a tube of aluminum or copper for example, passing through a passage formed in the block. It may be held in place by resin or solder, for example.

In the illustrated embodiments, the cavity 20 in each case is provided with a central pillar, 38. This pillar encourages an operator to assemble the twist 14 correctly coiled into the cavity 20. More importantly, the pillar provides an effective thermal conduction path from the center of the joint to the block 22, and thence to coolant flowing through the through-channel 26 or to the thermal conductor 34. The pillar is optional, but preferred. The pillar need not be located at the geometric center of the cavity 20.

The pillar provides additional surface area of the cooled block in contact with the joint. In use, a joint using Woods metal will tend to contract more than an aluminum or copper pillar, ensuring that good thermal contact is maintained onto the pillar. In other embodiments of the invention, the material of the block may contract more than the Woods metal, giving good thermal contact on the outer surface of the joint.

In certain embodiments, more than one joint cup cavity 20 may be formed in a single block 22. Such multiple joint cup cavities need not all be formed on the same side of the block. For example, a cuboid block 22 may have four joint cups 20 formed on respective sides, with the remaining two sides each carrying a fluid connector 28.

The block 22 containing one or more cavity 20 may be molded, or may be machined from an extrusion, or any other suitable process may be used.

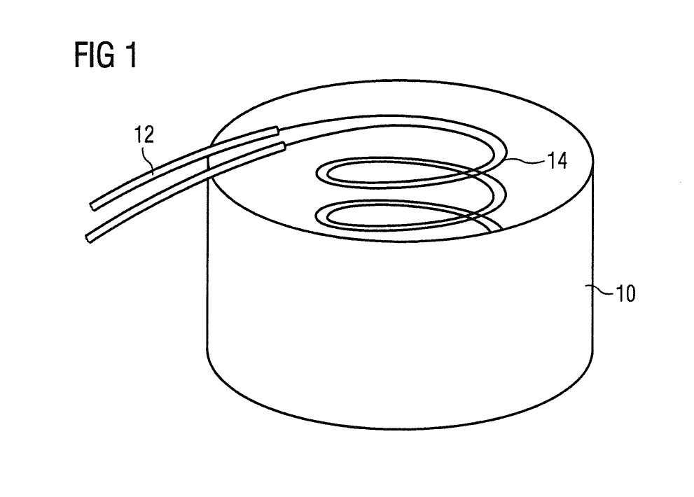

The superconducting joints of the present invention are more efficiently cooled than those of the prior art exemplified in FIG. 1, as they have a larger surface area in contact with the cooled block 22, and have only one thermal barrier of a relatively thin coating 30.

The effective thermal coupling between the block 22 and the joint in the joint cup cavity 20 acts as a thermal buffer in the event of quench in the joint, rapidly dissipating heat and enabling superconducting operation to be quickly re-established.

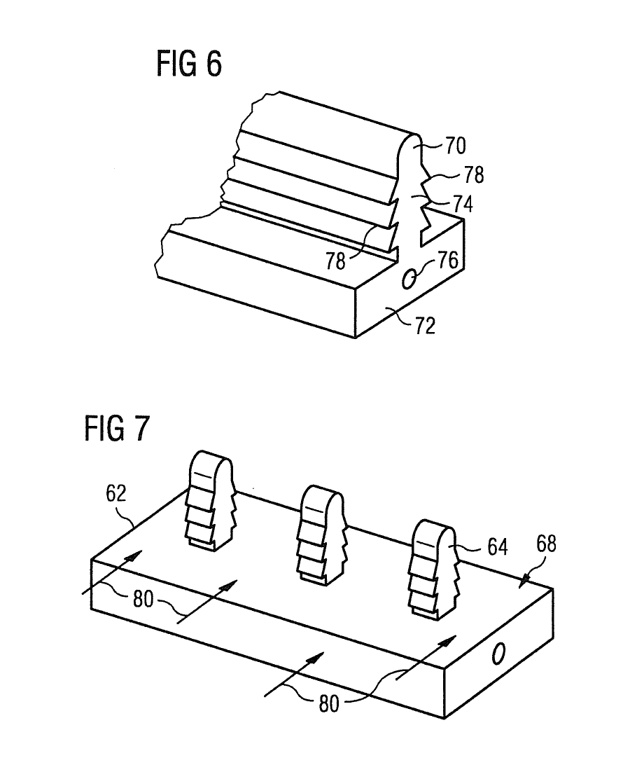

FIGS. 6-9 illustrate steps in a method for producing superconducting joints according to an embodiment of a variant of the present invention.

In this variant, a cooled block 62 is provided with integral columns 64 about which superconducting joints 66 are formed. Similarly to the embodiments described above, the columns and the adjacent surface 68 of the block are covered in an electrically insulating coating. That coating should be chosen to have a high thermal conduction, while providing electrical insulation to specified levels, typically in the region of 6-10 kV. It has been found that an aluminum block may be conveniently anodized to provide a layer of aluminum oxide sufficient to provide the required voltage isolation while having an acceptable thermal conductivity.

FIG. 6 shows an early step in the manufacture of the superconducting joints 66 of this variant of the present invention. An extrusion 70, for example of aluminum, is formed.

The extrusion profile defines a block part 72 and a fin part 74. In the illustrated embodiment, a through-channel 76 is provided in the block part during extrusion. Preferably, the profile of the fin part 74 is provided with protrusions or barbs 78, which will serve to retain the finished superconducting joints firmly in position.

As illustrated in FIG. 7, the extrusion 70 is cut to a required length to form block 62. A machining operation is then performed, in the direction shown by arrows 80. Sections of the fin part 74 are removed, to leave separated columns 64 distributed along the length of the block 62. When this step is complete, the resultant article is anodized, if of aluminum, or otherwise coated with an electrically isolating material. The anodizing, or other coating, is preferably not applied to the surface inside the through-channel 76. In an alternative embodiment, this may be achieved by omitting the through-channel 76 from the extrusion, and drilling the through-channel in the completed block 62 after anodizing, or other coating with electrical isolation, is complete.

In an example embodiment, in which superconducting joints are formed linking wires together in superconducting magnets for an MRI system, it was found necessary to provide electrical isolation to at least 6 kV, to withstand the very high voltages typically generated during a quench event. Particular examples of suitable coatings include:

a physical vapor deposited layer of polymer, to a thickness of approximately 25 μm;

a sprayed-on ceramic layer, to a thickness of 230-255 μm;

aluminum oxide, to a thickness of about 250 μm, formed by anodizing the surface of an aluminum block.

A physical vapor deposition process was found particularly beneficial in applying a coating of constant thickness to all exposed surfaces.

Other coatings may be used, and may be applied by a slurry or dipping process, or painted on.

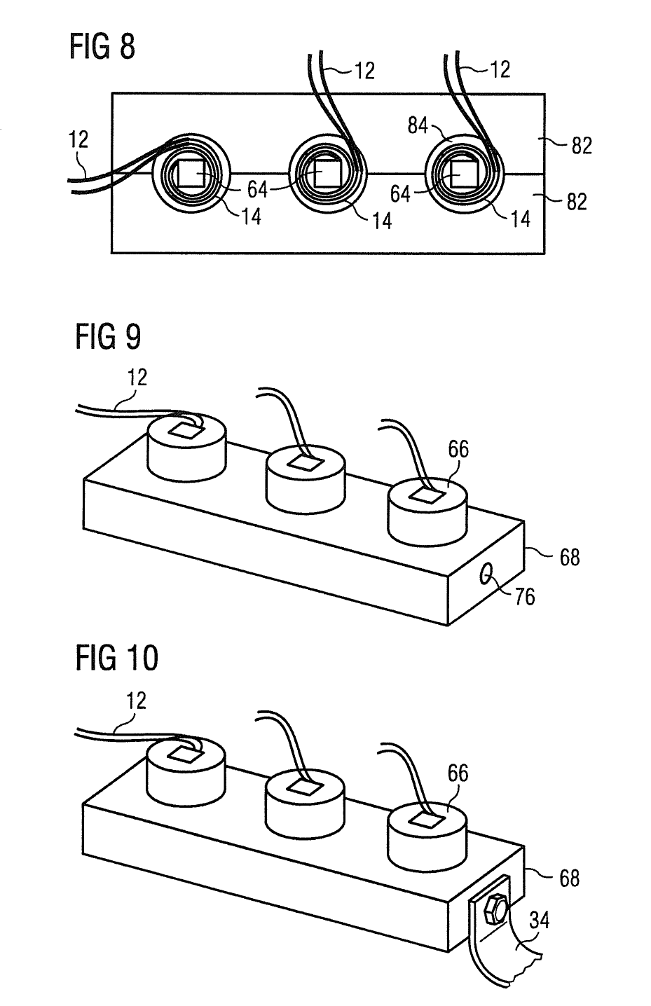

FIG. 8 shows a top view of a next stage in the process. A two-part mold 82 is placed on surface 68 of the block. The two-part mold includes cavities 84 which, when the mold is in position, define temporary joint cup cavities around the columns 64. Superconducting wires 12 to be joined, and particularly the twists 14 of superconducting filaments, are coiled into the temporary joint cup cavities. The temporary joint cup cavities are then filled with a superconducting joining material such as molten Woods metal. This material is allowed to harden. Once the superconducting joining material has hardened, the two-part mold 82 is removed, and the superconducting joints 66 remain, as illustrated in FIG. 9.

If the two-part mold is made of an inexpensive and electrically isolating material, or is coated with an electrically isolating material, then it may be left in position around the completed superconductive joints 66. If the mold is left in position, then it need not be in two parts. The mold may be in a single part and be left in position.

The mold may be formed in more than two parts, of course, if preferred.

The machinable glass ceramic material discussed above may be found suitable as a material for manufacturing the molds.

The through-channel 76 may be connected to fluid connectors such as shown at 28 in FIG. 4, and should be arranged to carry cryogen coolant, in the same manner as discussed with reference to FIGS. 2-4.

FIG. 10 shows another embodiment of the present invention. It is similar to the arrangement of FIG. 9, but comprises no through-channel 76 or fluid connectors. Rather, a flexible thermal conductor 34, in this example a flexible laminate such as a copper or aluminum laminate, is securely attached, in this example by bolt or screw 86 to a surface of the block 68, similar to the arrangement discussed with reference to FIG. 5. It is important in such embodiments that there should be no thermally isolating layer on the joining surfaces of the block 68 and the flexible thermal conductor 34. If preferred, a thermally conductive interface, such as an indium washer, may be interposed between the block 68 and the flexible thermal conductor 34 to ensure effective heat transfer from the block to the flexible thermal conductor. The other end of the flexible thermal conductor will be attached to a cooled surface, for example a cooling surface of a cryogenic refrigerator. This connection to the refrigerator may be indirect, in that the flexible thermal conductor 34 may be attached to another article which is itself thermally connected to a cooling surface of a cryogenic refrigerator. The flexible thermal conductor 34 may be a thermally conductive braid, such as a copper or aluminum braid. The flexible thermal conductor 34 may be replaced by a rigid thermal conductor such as an aluminum or copper bar.

In another alternative, the cooled block may be in direct contact with the cryogenic refrigerator, omitting the thermal link.

The cooled block may also serve as a thermal link between refrigerator and magnet in a dry system.

In alternative embodiments, the block 68 may be of copper, or a composite material containing thermally conductive filler such as aluminum or copper powder or wool to provide the required thermal conductivity. A copper block may have a thin coating, for example of copper oxide or a polymer layer formed or deposited on the surface 30 of the cavity 20. A block of composite material may be provided with an electrically isolating layer 30 of a polymer or resin.

In an example embodiment, in which superconducting joints are formed linking wires together in superconducting magnets for an MRI system, it was found necessary to provide electrical isolation to at least 6 kV, to withstand the very high voltages typically generated during a quench event. Particular examples of suitable coatings include:

a physical vapor deposited layer of polymer, to a thickness of approximately 25 μm;

a sprayed-on ceramic layer, to a thickness of 230-255 μm;

aluminum oxide, to a thickness of about 250 μm, formed by anodizing the surface of an aluminum block.

A physical vapor deposition process was found particularly beneficial in applying a coating of constant thickness to all exposed surfaces.

Other coatings may be used, and may be applied by a slurry or dipping process, or painted on.

In other embodiments, the block 68 may be of a machinable glass ceramic material, such as those marketed under the MACOR® brand by Ceramic Substrates and Components Ltd, Lukely Works, Carisbrooke Road, Newport, Isle of Wight, United Kingdom PO30 1DH (www.macor.info). In such embodiments, the material itself is electrically isolating, and so there is no need to provide an electrically isolating coating inside the cavity 20. The material may be machined by conventional methods such as drilling, milling and cutting. In similar embodiments, a block of filled resin may be provided with the joint cup cavity and coolant through-channel molded in, or machined in. A suitable resin may be Emerson and Cuming STYCAST® 2850 GT resin, which has a relatively high thermal conductivity, yet also a high electrical resistivity.

The present invention accordingly provides novel superconducting joints and methods for forming superconducting joints. The superconducting joints are separated from a cooled component by only a single thermally resistant interface. The joint cup cavities and cooled blocks of the present invention are simply formed of inexpensive materials and provide reliable superconducting joints for joining superconducting wires in situations where the joints will not be immersed in a cryogen.

While the present invention has been described with reference to a limited number of particular embodiments, numerous variations are possible within the scope of the invention, as will be apparent to those skilled in the art. For example, the pillars 38, 64 may be formed separately from the respective cooled block 22, 62, and joined onto the cooled block before the superconducting joint is formed.

Although the present invention has been described with particular reference to Woods metal as the material for forming the superconducting joint, any other materials having the required properties of superconduction at the temperature of operation, and a tolerable melting point, may be used. While it is common practice, and considered desirable, to twist superconducting filaments together before embedding them within a superconducting material to form a superconducting joint, the present invention does not require such twisting, and may be employed with the filaments not twisted together.

Several electrically isolating blocks, each containing one individual joint could be bolted or otherwise thermally and mechanically attached on to a cooled article, so that any number of joint cooling blocks may be cooled by a single cooled article.

I claim as my invention:—therefore:

1. A superconducting joint, electrically joining superconducting wires, comprising:
a block of thermally and electrically conductive material arranged to be cryogenically cooled;
an electrically isolating coating covering at least a part of a surface of the block; and
molded superconducting joint material in contact with the electrically isolating coating;
wherein superconducting filaments of the superconducting wires embedded within the molded superconducting joint material.

2. A superconducting joint according to claim 1, wherein the block is of a material comprising a metal, and the electrically isolating coating comprises an oxide of that metal.

3. A superconducting joint according to claim 2, wherein the metal is aluminum or copper.

4. A superconducting joint according to claim 1, wherein the electrically isolating coating comprises a layer of polymer.

5. A superconducting joint according to claim 1, wherein the electrically isolating coating comprises a ceramic layer.

6. A superconducting joint, electrically joining superconducting wires, comprising:
a block of thermally conductive but electrically isolating material arranged to be cryogenically cooled; and
molded superconducting joint material in contact with a surface of the block, wherein superconducting filaments of the superconducting wires are embedded within the molded superconducting joint material.

7. A superconducting joint according to claim 6, further comprising a pillar, mechanically joined to the cooled block, extending at least partially through the superconducting joint material.

8. A superconducting joint according to claim 7 wherein the pillar is of thermally conductive material and is in thermal contact with the cooled block.

9. A superconducting joint according to claim 8 wherein the pillar is of the material of the cooled block, and is integrally formed therewith.

10. A superconducting joint according to claim 6, wherein the superconducting joint material is molded within a cavity in a surface of the cooled block.

11. A superconducting joint according to claim 6, wherein the superconducting joint material is molded within a temporary mold, which is removed once molding is complete.

12. A superconducting joint according to claim 11 wherein the temporary mold is a multi-part temporary mold, and is dismantled before removal from the molded superconducting joint material.

13. A superconducting joint according to claim 6, wherein the block is arranged to be cryogenically cooled by provision of a through passage formed in the material of the block for carrying a flow of cryogen therethrough.

14. A superconducting joint according to claim 6, wherein the block is arranged to be cryogenically cooled by provision of a thermal conductor providing a path of thermal conduction from the block to a cryogenic refrigerator.

15. A superconducting joint according to claim 6, wherein a channel is provided in the material of the block, to accommodate the superconducting wires.

16. A superconducting joint according to claim 15, wherein the superconducting joint material is molded within a cavity on a surface of the cooled block, and wherein the channel joins a cavity in the material of the block near a lower extremity thereof.

17. A superconducting joint according to claim 15, wherein the superconducting joint material is molded within a cavity on a surface of the cooled block, and wherein the channel joins the cavity at an upper surface thereof.

18. A method for electrically joining superconducting wires, comprising the steps of:
providing a block of thermally and electrically conductive material;
providing an electrically isolating coating covering at least a part of a surface of the block;
providing a molding cavity exposed to the electrically isolating coating;
exposing superconducting filaments of the superconducting wires and placing the superconducting filaments into the molding cavity;
introducing liquid superconducting joint material into the molding cavity, thereby embedding the superconducting filaments within the superconducting joint material; and
allowing or causing the liquid superconducting joint material to solidify.

19. A method according to claim 18, wherein the block is of a material comprising aluminum and the electrically isolating layer is provided by anodizing the block to form a layer of aluminum oxide.

20. A method according to claim 18, the electrically isolating layer is a physical vapor deposited layer of polymer.

21. A method according to claim 18, wherein the electrically isolating layer is a sprayed-on ceramic layer.

22. A method for electrically joining superconducting wires, comprising:
providing a block of thermally conductive but electrically isolating material;
providing a molding cavity exposed to a surface of the block;
exposing superconducting filaments of the superconducting wires and placing the superconducting filaments into the molding cavity;
introducing liquid superconducting joint material into the molding cavity, thereby embedding the superconducting filaments within the superconducting joint material; and
allowing or causing the liquid superconducting joint material to solidify.

23. A method according to claim 22, further comprising providing a pillar, mechanically joined to the cooled block, within the molding cavity prior to the step of introducing liquid superconducting joint material.

24. A method according to claim 23 wherein the pillar is integrally formed of the material of the cooled block.

25. A method according to claim 22, wherein the cavity is formed in a surface of the cooled block.

26. A method according to claim 22, wherein the molding cavity is formed within a temporary mould, which is removed once moulding is complete.

27. A method according to claim 26 wherein the temporary mold is a multi-part temporary mold, and is dismantled before removal from the molded superconducting joint material.

28. A method according to claim 22, wherein a through passage is formed in the material of the block for carrying a flow of cryogen therethrough.

29. A method according to claim 22, wherein a thermal conductor is attached to the block, thereby providing a path of thermal conduction from the block to a cryogenic refrigerator.

30. A method according to claim 22, further comprising the step of forming a channel in the material of the block, to accommodate the superconducting wires.

31. A method according to claim 30, wherein the cavity is formed in a surface of the cooled block, and wherein the channel joins a cavity in the material of the block near a lower extremity thereof.

32. A method according to claim 30, wherein the cavity is formed in a surface of the cooled block, and wherein the channel joins the recess at an upper surface thereof.

33-34. (canceled)
